(19) United States
(12) Patent Application Publication
(10) Pub. No.: US 2025/0203348 A1
(43) Pub. Date: Jun. 19, 2025

(54) USER EQUIPMENT, ELECTRONIC DEVICE, WIRELESS COMMUNICATION METHOD, AND STORAGE MEDIUM

(71) Applicant: Sony Group Corporation, Tokyo (JP)

(72) Inventors: Jin XU, Beijing (CN); Yuyan PENG, Beijing (CN); Jianfei CAO, Beijing (CN)

(73) Assignee: Sony Group Corporation, Tokyo (JP)

(21) Appl. No.: 18/848,939

(22) PCT Filed: Mar. 24, 2023
(86) PCT No.: PCT/CN2023/083578

§ 371 Date: Sep. 20, 2024

(30) Foreign Application Priority Data
Apr. 1, 2022 (CN) 202210339010.2

(51) Int. Cl. H04W 8/24; H04L 5/00; H04W 72/044; H04W 72/21

(52) U.S. Cl. CPC H04W 8/24; H04L 5/0055; H04W 72/046; H04W 72/21

(57) ABSTRACT

A user equipment includes a processing circuit configured to: generate panel information, wherein the panel information includes a user capability value set of each of a plurality of panels of the user equipment, and user capability values in user capability value sets of different panels are the same or different; and send the panel information to a network side device. The user equipment, the electronic equipment, the wireless communication method and the storage medium are used, so that the user equipment can report two panels having a same user capability value, and the details of feeding back beam quality information by the electronic equipment and the details of scheduling a plurality of panels of the user equipment by the electronic equipment are designed, thereby optimizing the multi-panel uplink transmission of the user equipment.

The present application claims the priority to Chinese Patent Application No. 202210339010.2, titled “USER EQUIPMENT, ELECTRONIC DEVICE, WIRELESS COMMUNICATION METHOD, AND STORAGE MEDIUM”, filed on Apr. 1, 2022 with the China National Intellectual Property Administration, which is incorporated herein by reference in its entirety.

### FIELD

The present disclosure generally relates to the field of wireless communications, and in particular to user equipment, an electronic device, a wireless communication method and a computer-readable storage medium. More specifically, the present disclosure relates to user equipment in a wireless communication system, an electronic apparatus serving as network side apparatus in a wireless communication system, a wireless communication method performed by user equipment in a wireless communication system, a wireless communication method performed by network side apparatus in a wireless communication system, and a computer-readable storage medium.

### BACKGROUND

User equipment may be equipped with multiple antenna panels, abbreviated as panels, to cover multiple different directions. For example, each panel of the user equipment faces towards one direction and sends one or more beams. The user equipment may report a plurality of panels of the user equipment by using a user capability value set (UE capability value set) to network side apparatus, and each user capability value set corresponding to one panel. The user capability value set may include one or more user capability values. In the existing protocol, user equipment is not allowed to report two user capability value sets with a same user capability value. That is, if the user equipment has two panels and the user capability values in the user capability value sets of the two panels are the same, the user equipment is not allowed to report both panels to the network side apparatus simultaneously, that is, the network side apparatus fails to schedule the two panels simultaneously. As a result, application scenarios of scheduling a plurality of panels in the uplink transmission are greatly limited.

In addition, in the existing protocol, in a scenario where the user equipment is equipped with multiple antenna panels, it is not determined whether and how the network side apparatus sends feedback information after the user equipment reports beam quality information to the network side apparatus. Furthermore, how to perform uplink scheduling is also a technical problem to be solved if it is determined that the network side apparatus schedules a plurality of panels for uplink transmission of the user equipment.

Therefore, it is required to provide a technical solution to optimize the uplink transmission process of a plurality of panels of the user equipment.

### SUMMARY

This summary section provides a general summary of the present disclosure, rather than a comprehensive disclosure of its full scope or its features.

An objective of the present disclosure is to provide user equipment, an electronic apparatus, a wireless communication method, and a computer-readable storage medium, to optimize the uplink transmission process of a plurality of panels of the user equipment.

According to an aspect of the present disclosure, user equipment is provided. The user equipment includes processing circuitry. The processing circuitry is configured to: generate panel information including a user capability value set of each of a plurality of panels of the user equipment, where user capability values in user capability value sets of different panels are the same or different; and send the panel information to network side apparatus.

According to another aspect of the present disclosure, an electronic apparatus is provided. The electronic apparatus includes processing circuitry. The processing circuitry is configured to receive panel information from user equipment; and determine a user capability value set of each of a plurality of panels of the user equipment according to the panel information, where user capability values in user capability value sets of different panels are the same or different.

According to another aspect of the present disclosure, a wireless communication method performed by user equipment is provided. The wireless communication method includes generating panel information, the panel information including a user capability value set of each of a plurality of panels of the user equipment, where user capability values in user capability value sets of different panels are the same or different; and sending the panel information to network side apparatus.

According to another aspect of the present disclosure, a wireless communication method performed by electronic apparatus is provided. The wireless communication method includes receiving panel information from user equipment; and determining a user capability value set of each of a plurality of panels of the user equipment according to the panel information, where user capability values in user capability value sets of different panels are the same or different.

According to another aspect of the present disclosure, a computer-readable storage medium including executable computer instructions is provided. The executable computer instructions, when being executed by a computer, cause the computer to perform the wireless communication method according to the present disclosure.

According to another aspect of the present disclosure, a computer program is provided. The computer program, when executed by a computer, causes the computer to execute the wireless communication method according to the present disclosure.

With the user equipment, the electronic apparatus, the wireless communication method, and the computer-readable storage medium according to the present disclosure, in the panel information reported by the user equipment, the user capability values in user capability value sets of different panels are the same or different. That is, according to the present disclosure, the restriction on the user equipment that is not allowed to report two panels with the same user capability value is eliminated, that is, the restriction on uplink transmission of a plurality of panels is eliminated, so that the user equipment can report any panel, thereby optimizing the uplink transmission process of a plurality of panels of the user equipment.

A further applicable field becomes apparent from the description herein. The descriptions and specific examples in the summary are only illustrative and are not intended to limit the scope of the present disclosure.

### BRIEF DESCRIPTION OF THE DRAWINGS

The drawings are only used for illustrating the selected embodiments rather than all possible implementations, and are not intended to limit the scope of the present disclosure. In the drawings:

FIG. 1 is a block diagram illustrating an example of a configuration of user equipment according to an embodiment of the present disclosure;

FIG. 2 is a schematic diagram illustrating that network side apparatus sends feedback information by using a DCI format 0_1 according to an embodiment of the present disclosure;

FIG. 3 is a schematic diagram illustrating that network side apparatus sends feedback information by using a DCI format 2_x according to an embodiment of the present disclosure;

FIG. 4 is a schematic diagram illustrating that network side apparatus sends feedback information by using a DCI format 1_1 according to an embodiment of the present disclosure;

FIG. 5 is a schematic diagram illustrating that network side apparatus sends feedback information by using a DCI format 1_2 according to an embodiment of the present disclosure;

FIG. 6 is a block diagram illustrating an example of a configuration of electronic apparatus as network side apparatus according to an embodiment of the present disclosure;

FIG. 7 is a signaling flowchart of a process of scheduling a plurality of panels of user equipment according to an embodiment of the present disclosure;

FIG. 8 is a flowchart illustrating a wireless communication method performed by user equipment according to an embodiment of the present disclosure.

FIG. 9 is a flowchart illustrating a wireless communication method performed by electronic apparatus as network side apparatus according to another embodiment of the present disclosure;

FIG. 10 is a block diagram illustrating a first example of a schematic configuration of an Evolved Node B (eNB);

FIG. 11 is a block diagram illustrating a second example of a schematic configuration of a gNB;

FIG. 12 is a block diagram illustrating an example of a schematic configuration of a smartphone; and

FIG. 13 is a block diagram illustrating an example of schematic configuration of a car navigation apparatus.

Although various modification and alternations are easily made onto the present disclosure, the specific embodiments are shown in the drawings as an example, and are described in detail here. It should be understood that description for the specific embodiments is not intended to limit the present disclosure into a disclosed specific form, and the present disclosure aims to cover all modification, equivalents and alternations within the spirit and scope of the present disclosure. It should be noted that a label indicates a component corresponding to the label through the drawings.

### DETAILED DESCRIPTION OF EMBODIMENTS

Examples of the present disclosure are fully disclosed with reference to the drawings. The following description is merely exemplary and is not intended to limit the present disclosure and an application or use thereof.

Exemplary embodiments are provided, so that the present disclosure becomes thorough and fully convey the scope thereof to those skilled in the art. Examples of specific components, apparatus, methods and other specific details are set forth to provide detailed understanding of embodiments of the present disclosure. It will be apparent to those skilled in the art that exemplary embodiments may be implemented in many different forms without the use of specific details, and they should not be construed as limiting the scope of the present disclosure. In some exemplary embodiments, well-known processes, structures and technologies are not described in detail.

Description is made in the following order:

1. Problem description;
2. Configuration examples of user equipment;
3. Configuration examples of network side apparatus;
4. Embodiments of method; and
5. Application examples.

### <1. Problem Description>

As described above, in the existing protocol, user equipment is not allowed to report two user capability value sets with a same user capability value, which greatly limits the application scenarios of scheduling a plurality of panels in uplink transmission. In addition, which antenna panel or which parameters of the antenna panel is used as user capability values in the user capability value set is not specified in the existing protocol. In addition, in the existing protocol, it is not determined whether and how the network side apparatus sends feedback information after the user equipment reports beam quality information to network side apparatus. Furthermore, how to schedule a plurality of panels in the uplink transmission is not described in detail in the existing protocol.

For such a scenario, electronic apparatus in a wireless communication system, a wireless communication method performed by electronic apparatus in a wireless communication system, and a computer-readable storage medium are provided according to the present disclosure, to optimize an uplink transmission process of a plurality of panels of user equipment.

The wireless communication system according to the present disclosure may be a 5G NR communication system or a 6G or a higher-level communication system.

The network side apparatus according to the present disclosure may be base station equipment, for example, an eNB, or a gNB (a base station in a fifth generation communication system).

The user equipment according to the present disclosure may be a mobile terminal (such as a smartphone, a tablet personal computer (PC), a notebook PC, a portable game terminal, a portable/dongle type mobile router and a digital camera) or a vehicle-mounted terminal (such as a car navigation apparatus). The user equipment may also be implemented as a terminal (also referred to as a machine-type communication (MTC) terminal) that performs machine-to-machine (M2M) communication. Furthermore, the user equipment may be a wireless communication module (such as an integrated circuitry module including a single die) mounted on each of the terminals described above. In addition, the user equipment according to the present disclosure may be provided multiple antenna panels.

### <2. Configuration Examples of User Equipment>

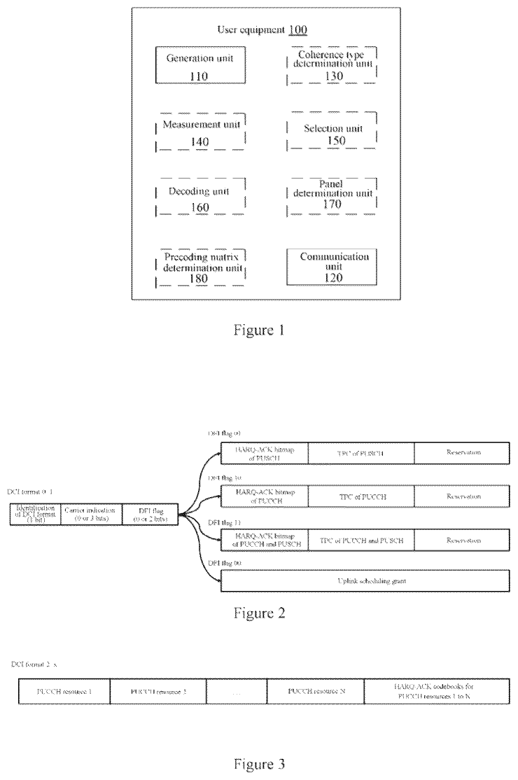

FIG. 1 is a block diagram illustrating an example of a configuration of user equipment 100 according to an embodiment of the present disclosure.

As shown in FIG. 1, the user equipment 100 may include a generation unit 110 and a communication unit 120.

Here, each unit of the user equipment 100 may be included in processing circuitry. It should be noted that the user equipment 100 may include one or more processing circuitry. Furthermore, the processing circuitry may include various discrete functional units to perform various different functions and/or operations. It should be noted that these functional units may be physical entities or logical entities, and units with different names may be implemented by the same physical entity.

According to the embodiment of the present disclosure, the generation unit 110 may generate panel information. Here, the panel information may include a user capability value set of each of a plurality of panels of the user equipment 100. Furthermore, user capability values (UE capability values) in user capability value sets of different panels are the same or different.

According to the embodiment of the present disclosure, the user equipment 100 may send the panel information to network side apparatus via the communication unit 120. The network side apparatus herein may be configured to provide service for the user equipment 100

It can be seen that in the user equipment 100 according to the embodiment of the present disclosure, in the reported panel information, the user capability values in user capability value sets of different panels are the same or different. That is, according to the present disclosure, the restriction on the user equipment that is not allowed to report two panels with the same user capability value is eliminated, that is, the restriction on uplink transmission of a plurality of panels is eliminated, so that the user equipment can report any panel, thereby optimizing the uplink transmission process of a plurality of panels of the user equipment.

According to the embodiment of the present disclosure, as shown in FIG. 1, the user equipment 100 may further include a coherence type determination unit 130. The coherence type determination unit 130 is configured to determine an intra-panel coherence type of each of all panels of the user equipment 100. Furthermore, the generation unit 110 may determine the intra-panel coherence type as one user capability value, to cause the user capability value to be included in the user capability value set of the panel.

According to the embodiment of the present disclosure, the intra-panel coherence type represents a coherence situation among multiple ports of a panel, the coherence situation among the multiple ports of the panel includes full coherence, partial coherence, and incoherence.

According to the embodiment of the present disclosure, in a case where any two SRS ports among all SRS ports of the panel are coherent, the coherence type determination unit 130 may determine that the intra-panel coherence type of the panel is full coherence. Here, two coherent SRS ports refer to that a phase difference between the two SRS ports is constant, and thus the two SRS ports may use a same precoding matrix. That is, in a case of full coherence, all SRS ports of the panel use a same precoding matrix. For example, a panel A includes 4 SRS ports numbered 1 to 4, and any two SRS ports among the 4 SRS ports are coherent, that is, the 4 SRS ports use a same precoding matrix a, and thus the intra-panel coherence type of the panel A is full coherence.

According to the embodiment of the present disclosure, in a case where any two SRS ports among all SRS ports of the panel are incoherent, the coherence type determination unit 130 may determine that the intra-panel coherence type of the panel is incoherence. Here, two incoherence SRS ports refers to that a phase difference between the two SRS ports is not constant, that is, the phase difference varies over time. Therefore, the two SRS ports use different precoding matrices. That is, in a case of incoherence, all SRS ports of the panel use different precoding matrices. For example, a panel B includes 4 SRS ports numbered 1 to 4, and any two SRS ports among the 4 SRS ports are incoherent, that is, the 4 SRS ports use different precoding matrices a, b, c, and d, and thus the intra-panel coherence type of the panel B is incoherence.

According to the embodiment of the present disclosure, in a case where a part of all SRS ports of the panel are coherent, the coherence type determination unit 130 may determine that the intra-panel coherence type of the panel is partial coherence. That is, in a case of partial coherence, a part of all the SRS ports of the panel use a same precoding matrix. For example, a panel C includes 4 SRS ports numbered 1 to 4, and ports 1 and 2 among the 4 SRS ports are coherent and use a same precoding matrix a, a port 3 uses a precoding matrix b, a port 4 uses a precoding matrix c, and thus the intra-panel coherence type of the panel C is partial coherence.

According to the embodiment of the present disclosure, in a case where multiple ports of the panel are partially coherent, the coherence situation among the multiple ports of the panel further includes partially coherent ports. For example, in a case where ports 1 and 2 of the panel C are coherent, the coherence situation among the multiple ports of the panel may further include information indicating the coherence of 1 and 2, that is, the user capability value includes not only information indicating partial coherence, but also the partially coherent ports of the panel.

According to the embodiment of the present disclosure, the user capability value may further include the number of SRS ports, that is, the generation unit 110 may determine the number of the SRS ports of the panel as one user capability value, to cause the user capability value to be included in the user capability value set of the panel. That is, the user capability value set of each panel may include two user capability values: the number of SRS ports; and the intra-panel coherence type.

According to the embodiment of the present disclosure, the user capability value set of each panel may include one or more user capability values. user capability values in user capability value sets of two panels are the same, which indicates that all user capability values in the user capability value sets of the two panels are the same. Otherwise, user capability values in the user capability value sets of the two panels are different. Furthermore, according to the embodiment of the present disclosure, in a case where the user capability values in the user capability value sets of the two panels are the same, it can also be said that the user capability value sets of the two panels are the same.

That is, in a case where the user capability value set of each panel includes the number of SRS ports and the intra-panel coherence type, and two user capability values, i.e., the number of SRS ports and the intra-panel coherence type of one panel are the same as the number of SRS ports and the intra-panel coherence type of another panel, respectively, the user capability value sets of the two panels are the same. Otherwise, the user capability value sets of the two panels are different. For example, the number of SRS ports of the panel D is the same as the number of SRS ports of the panel E, the intra-panel coherence type of the panel D is partial coherence, where ports 1 and 2 are coherent, ports 3 and 4 are coherent, and the intra-panel coherence type of the panel E is partial coherence, where ports 1 and 4 are coherent, and ports 2 and 3 are coherent, and thus the user capability value set of the panel D is different from the user capability value set of the panel E. For example, if the number of SRS ports of a panel F is the same as the number of SRS ports of a panel G, the intra-panel coherence type of the panel F is full coherence, and the intra-panel coherence type of the panel G is full coherence, the user capability value set of the panel F is the same as the user capability value set of the panel G.

As described above, according to the embodiment of the present disclosure, the number of SRS ports of the panel and/or intra-panel coherence type of the panel may serve as user capability value, to cause the number of SRS ports of the panel and/or intra-panel coherence type of the panel to be included in the user capability value set of the panel. That is, two parameters that may serve as user capability value are defined in the present disclosure.

According to the embodiment of the present disclosure, after determining the user capability value set of each of all the panels of the user equipment 100 as described above, the generation unit 110 may control the user capability value set of each panel to be included in the panel information.

It can be seen that according to the embodiment of the present disclosure, regardless of whether the user capability value sets are the same, the user equipment may report the panel to the network side apparatus, that is, there is no restriction on scheduling a plurality of panels at the network side.

According to the embodiment of the present disclosure, after reporting the panel information, the user equipment 100 may receive RRC configuration information from the network side apparatus via the communication unit 120.

According to the embodiment of the present disclosure, as shown in FIG. 1, the user equipment 100 may further include a measurement unit 140. The measurement unit 140 is configured to measure channel quality of each beam according to a reference signal from the network side apparatus. Here, the user equipment 100 may be equipped with a plurality of panels, each of the panels includes one or more beams, so that the measurement unit 140 may measure the channel quality of each beam of each panel.

Parameters representing the channel quality is not limited in the present disclosure. For example, L1-RSRP (Lay 1-Reference Signal Receiving Power) or L1-SINR (Lay 1-Signal to Interference plus Noise Ratio) may be used to represent the channel quality of each beam.

According to the embodiment of the present disclosure, as shown in FIG. 1, the user equipment 100 may further include a selection unit 150. The selection unit 150 is configured to select a preferred beam for each panel, that is, to select a beam with the best channel quality for each panel.

According to the embodiment of the present disclosure, the generation unit 110 may further generate beam quality information for each panel. The beam quality information includes a preferred beam of the panel, so that the user equipment 100 can send the beam quality information to the network side apparatus via the communication unit 120.

According to the embodiment of the present disclosure, the preferred beam of the panel may be represented by panel indication information and beam indication information. Furthermore, since the panel and the user capability value set are in one-to-one correspondence, the panel indication information may be represented by identification information of the user capability value set (UE capability value set ID). In addition, since a downlink reference signal of the network side apparatus and the beam are in one-to-one correspondence, the beam indication information may be represented by CRI (CSI-RS resource indicator) or SSBRI (SSB (Synchronization Signal block) resource indicator). That is, the beam quality information of each panel may include the panel indication information and the beam indication information.

According to the embodiment of the present disclosure, the coherence type determination unit 130 may further determine an inter-panel coherence type of each panel, and the generation unit 110 may control the inter-panel coherence type to be included in the beam quality information.

According to the embodiment of the present disclosure, the inter-panel coherence type of the panel may represent a coherence situation between the panel and other panels. The coherence situation between the panel and other panels includes incoherence and coherence.

According to the embodiment of the present disclosure, if an intra-panel coherence type of a panel X is full coherence, an intra-panel coherence type of a panel Y is full coherence, and a phase difference between the various ports of the panel X is constant and a phase difference between the various ports of the panel Y is constant, the inter-panel coherence type of the panel X is coherence, and the inter-panel coherence type of the panel Y is coherence. In such case, various ports of the panel X and various ports of the panel Y may use a same precoding matrix.

For each panel, the coherence type determination unit 130 may determine whether the user equipment 100 includes other panel coherent with the panel. If there is no other panel coherent with the panel, the inter-panel coherence type of the panel is incoherence. If there is other panel coherent with the panel, the inter-panel coherence type of the panel is coherence. Furthermore, in a case where there is other panel coherent with the panel, the coherence situation between the panel and other panels further includes information of other panels coherent with the panel. For example, other panel may be represented by the identification information of the user capability value set. For example, if the panel X is coherent with the panel Y, the inter-panel coherence type of the panel X is coherence, and the inter-panel coherence type of the panel X includes information of the panel Y. The inter-panel coherence type of the panel Y is coherence, and the inter-panel coherence type of the panel Y includes information of the panel X.

According to the embodiment of the present disclosure, the generation unit 110 may further control the channel quality information of the preferred beam of the panel to be included in the beam quality information. The channel quality information includes but is not limited to L1-RSRP and L1-SINR.

As described above, the generation unit 110 may generate beam quality information for each panel. The beam quality information includes one or more of the following: the inter-panel coherence type of the panel; the preferred beam of the panel; and the channel quality information of the preferred beam of the panel.

As described above, according to the embodiment of the present disclosure, the user equipment 100 may report the inter-panel coherence type when reporting the beam quality information to the network side apparatus. In addition, the user equipment 100 may report the intra-panel coherence type when reporting the panel information to the network side apparatus. In this way, it is convenient for the network side apparatus to schedule panels for uplink transmission for the user equipment 100, and to determine the precoding matrix for each panel according to the intra-panel coherence type and the inter-panel coherence type of each panel.

According to the embodiment of the present disclosure, after sending the beam quality information to the network side apparatus, the user equipment 100 may receive feedback information for the beam quality information from the network side apparatus via the communication unit 120.

According to the embodiment of the present disclosure, as shown in FIG. 1, the user equipment 100 may further include a decoding unit 160. The decoding unit 160 is configured to decode the feedback information to determine whether the network side apparatus has received the beam quality information.

According to the embodiment of the present disclosure, the user equipment 100 may send the beam quality information by using PUCCH, such as UCI (Uplink Control Information) in PUCCH. In this case, the network side apparatus send the feedback information by using a DCI format 0 or a DCI format 2, so that the decoding unit 160 decodes the feedback information to determine ACK and NACK. In a case where the decoding unit 160 determines ACK, the user equipment 100 may determine that the network side apparatus has received the beam quality information. In a case where the decoding unit 160 determines NACK, the user equipment 100 may determine that no beam quality information is received by the network side apparatus. Two scenarios where the network side apparatus sends the feedback information by using the DCI format 0 and the DCI format 2 are described hereinafter in detail.

According to the embodiment of the present disclosure, the network side apparatus may send the feedback information by using the DCI format 0, such as a DCI format 0_1. Specifically, if the user equipment 100 requires information of the DCI format 0_1, the user equipment 100 may determine whether the information is feedback of PUSCH, PUCCH, or PUSCH and PUCCH based on a DFI (Downlink Feedback Information) flag, and then determine ACK or NACK based on HARQ-ACK bitmap of PUCCH or HARQ-ACK bitmap of PUSCH and PUCCH.

FIG. 2 is a schematic diagram illustrating that network side apparatus sends feedback information by using a DCI format 0_1 according to an embodiment of the present disclosure. As shown in FIG. 2, the DCI format 0_1 includes identification of DCI format, carrier indication, a DFI flag, HARQ-ACK bitmap, TPC (Transmission Power Control), and a reserved bit. In a case where the DFI flag is 01, the HARQ-ACK bitmap represents the HARQ-ACK bitmap for PUSCH, and TPC represents TPC for PUSCH. In a case where the DFI flag is 10, the HARQ-ACK bitmap represents the HARQ-ACK bitmap for PUCCH, and TPC represents TPC for PUCCH. In a case where the DFI flag is 11, the HARQ-ACK bitmap represents the HARQ-ACK bitmap for PUSCH and PUCCH, and TPC represents TPC for PUSCH and PUCCH. In a case where the DFI flag is 00, there is no HARQ-ACK bitmap, TPC, and reserved bit information, indicating uplink grant information.

As described above, in a case where the user equipment 100 sends the beam quality information by using PUCCH, and the network side apparatus sends ACK or NACK, the network side apparatus may carry feedback information by reusing the DCI format 0_1, and the DCI format 0_1 is only slightly modified for carrying the feedback information.

According to the embodiment of the present disclosure, the network side apparatus may send the feedback information by using the DCI format 2, such as DCI format 2_x. Specifically, after the user equipment 100 acquires the information of the DCI format 2_x, based on PUCCH resources of sending the beam quality information by that the user equipment 100, the feedback information of the user equipment 100 may be determined from HARQ-ACK codebook for all the PUCCH resources, thereby determining ACK or NACK.

FIG. 3 is a schematic diagram illustrating that network side apparatus sends feedback information by using a DCI format 2_x according to an embodiment of the present disclosure. As shown in FIG. 3, the DCI format 2_x includes PUCCH resources 1 to N, and HARQ-ACK codebooks for the PUCCH resources 1 to N.

As described above, in a case where the user equipment 100 sends the beam quality information by using PUCCH, and the network side apparatus sends ACK or NACK, the network side apparatus may design a new DCI format 2_x to carry the feedback information.

Furthermore, the user equipment 100 may decode the DCI format by using RNTI (Radio Network Temporary Identity) dedicated to the DCI format 2_x.

According to the embodiment of the present disclosure, the user equipment 100 may send the beam quality information by using PUCCH, such as UCI (Uplink Control Information) in PUCCH. In this case, the network side apparatus may send the feedback information by using the DCI format 1, such as a DCI format 1_1 and a DCI format 1_2, so that the decoding unit 160 decodes the feedback information to determine the NACK. In a case where the decoding unit 160 determines NACK, the user equipment 100 may determine that no beam quality information is received by the network side apparatus. In a case where no NACK is received by the user equipment 100, the user equipment 100 may determine that the network side apparatus has received the beam quality information. In this way, the network side apparatus can only provide feedback on NACK, greatly reducing signaling overhead. Two scenarios where the network side apparatus sends the feedback information by using the DCI format 1_1 and the DCI format 1_2 are described hereinafter in detail.

According to the embodiment of the present disclosure, the network side apparatus may represent NACK feedback information by using a specific value of one or more fields in the DCI format 1_1. For example, the network side apparatus may represent NACK by using a specific value of one or more of a RV (Redundancy Version) field, an MCS (Modulation and Coding Scheme) field, and an FDRA (Frequency Domain Resource Assignment) field. As a non-limiting example, if the user equipment 100 determines that all values of the RV field are 1, all values of the MCS field are 1, and all values of the FDRA field are 0 based on the DCI format 1_1, the user equipment 100 may determine NACK, that is, no beam quality information is received by the network side apparatus. Otherwise, the user equipment 100 determines that the network side apparatus has received the beam quality information.

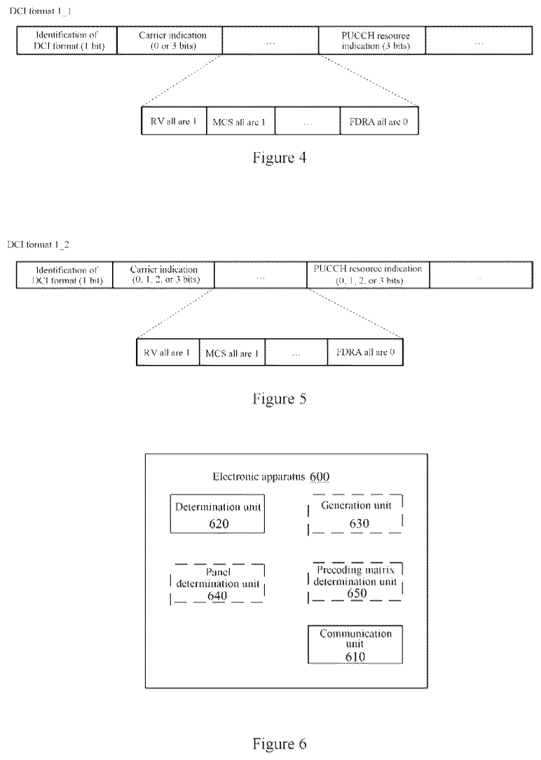

FIG. 4 is a schematic diagram illustrating that network side apparatus sends feedback information by using a DCI format 1_1 according to an embodiment of the present disclosure. As shown in FIG. 4, the DCI format 1_1 includes identification of DCI format, a carrier indication, the RV field, the MCS field, the FDRA field, and a PUCCH resource indication. In a case where all values of the RV field are 1, all values of the MCS field are 1, and all values of the FDRA field are 0, the user equipment 100 may determine that NACK information is received.

According to the embodiment of the present disclosure, the network side apparatus may represent NACK feedback information by using a specific value of one or more fields in DCI format 1_2. For example, the network side apparatus may represent NACK by using one or more specific values of the RV (Redundancy Version) field, the MCS (Modulation and Coding Scheme) field, and the FDRA (Frequency Domain Resource Assignment) field. As a non-limiting example, if the user equipment 10 determines that all values of the RV field are 1, all values of the MCS field are 1, and all values of the FDRA field are 0 based on the DCI format 1_2, the user equipment 100 may determine NACK, that is, no beam quality information is received by the network side apparatus. Otherwise, the user equipment 100 determines that the network side apparatus has received the beam quality information.

FIG. 5 is a schematic diagram illustrating that network side apparatus sends feedback information by using a DCI format 1_2 according to an embodiment of the present disclosure. As shown in FIG. 5, the DCI format 1_2 includes identification of DCI format, the carrier indication, the RV field, the MCS field, the FDRA field, and the PUCCH resource indication. In a case where all values of the RV field are 1, all values of the MCS field are 1, and all values of the FDRA field are 0, the user equipment 100 may determine that NACK information is received.

It should be noted that although the above embodiment in which the NACK information is indicated by using all values of the RV field being 1, all values of the MCS field being 1, and all values of the FDRA field being 0 is described, the embodiment is not restrictive. The network side apparatus may represent NACK by using other combinations of fields and other specific values of fields.

As described above, according to the embodiment of the present disclosure, in a case where the user equipment 100 sends the beam quality information by using PUCCH, and the network side apparatus only feedbacks NACK but does not feedback ACK, the network side apparatus may carry feedback information by reusing the DCI format 1.

According to the embodiment of the present disclosure, the user equipment 100 may send the beam quality information by using PUSCH, such as UCI or MAC CE in PUSCH. In this case, the network side apparatus may send feedback information by using the DCI format 0, such as DCI format 0_0 and the DCI format 0_1, so that the decoding unit 160 decodes the feedback information to determine the feedback information.

Specifically, the network side apparatus may represent ACK or NACK by using content of a NDI (New Data Indicator) field in uplink grant in the DCI format 0_0 or the DCI format 0_1. If the user equipment 100 receives the DCI format 0_0 or the DCI format 0_1, the user equipment 100 may determine whether the network side apparatus has received the beam quality information based on the value of the NDI field. For example, if the value of the NDI field is 1, it indicates an ACK message, that is, the network side apparatus has received the beam quality information. If the value of the NDI field is 0, it indicates an NACK message, that is, no beam quality information is received by the network side apparatus. Furthermore, the user equipment 100 may determine an NDI corresponding to the sent beam quality information based on the HARQ process identification information (HARQ process ID).

As described above, according to the embodiment of the present disclosure, in a case where the user equipment 100 sends the beam quality information by using PUSCH, the network side apparatus may carry feedback information via the identification information and the NDI field of the HARQ process in the DCI format 0.

According to the embodiment of the present disclosure, in a case where the user equipment 100 determines that no beam quality information is received by the network side apparatus, the user equipment 100 may resend the beam quality information.

As described above, the network side apparatus is required to provide feedback on the beam quality information sent by the user equipment 100 in the present disclosure. Furthermore, details of sending the feedback information by the network side apparatus are provided according to the present disclosure, so as to improve the reliability of the beam quality information.

According to the embodiment of the present disclosure, the user equipment 100 may further receive uplink scheduling information from the network side apparatus via the communication unit 120. For example, the user equipment 100 may receive uplink scheduling information based on the DCI format 0.

According to the embodiment of the present disclosure, the uplink scheduling information may include multiple SRIs (SRS Resource Indicators). As shown in FIG. 1, the user equipment 100 may further include a panel determination unit 170. The panel determination unit 170 is configured to determine a plurality of panels for uplink transmission based on multiple SRIs in the uplink scheduling information.

According to the embodiment of the present disclosure, the SRI may be used to indicate one SRS Resource in one SRS Resource Set, and the SRS Resource has a one-to-one correspondence with the uplink beam, and thus may be used to indicate a specific beam of the user equipment 100, that is, to indicate a specific panel of the user equipment 100. That is, the panel determination unit 170 may determine one panel based on each SRI, thereby determining a plurality of panels based on the multiple SRIs.

According to the embodiment of the present disclosure, the uplink scheduling information may also include an SRI, and the panel determination unit 170 is configured to determine a plurality of panels for uplink transmission based on one SRI in the uplink scheduling information.

According to the embodiment of the present disclosure, a mapping relationship between a beam combination and the SRI may be preset between the user equipment 100 and the network side apparatus. That is, various combinations of beams on different panels may be listed, and each combination has a mapping relationship with an SRI. In this way, the user equipment 100 may determine the beam combination based on one SRI in the uplink scheduling information, that is, determine multiple SRS resources in multiple SRS resource sets, thereby determining multiple beams and determining a panel where the multiple beams are located.

It can be seen that the user equipment 100 may determine multiple beams on a plurality of panels scheduled by the network side apparatus based on uplink scheduling information from the network side apparatus.

According to the embodiment of the present disclosure, the uplink scheduling information may further include TPMI (Transmission Precoder Matrix Index). As shown in FIG. 1, the user equipment 100 may further include a precoding matrix determination unit 180. The precoding matrix determination unit 180 is configured to determine a precoding matrix of a plurality of panels scheduled by the network side apparatus based on the TPMI in the uplink scheduling information.

According to the embodiment of the present disclosure, in a case where the uplink scheduling information includes one TPMI, it indicates that a plurality of panels scheduled by the network side apparatus are coherent, and thus the plurality of panels may use a same precoding matrix. Therefore, the precoding matrix determination unit 180 may determine the precoding matrix indicated by the TPMI as the precoding matrix for a plurality of panels.

According to the embodiment of the present disclosure, in a case where the uplink scheduling information includes multiple TPMIs, it indicates that a plurality of panels scheduled by the network side apparatus are incoherent, and thus the plurality of panels may use different precoding matrices. Furthermore, the precoding matrix determination unit 180 may further determine the number of the precoding matrices for each panel, i.e., the number of the TPMI, based on the intra-panel coherence type of each scheduled panel. That is, in a case where the intra-panel coherence type is full coherence, all ports of the panel use a same precoding matrix, that is, the number of the TPMI is 1. In a case where the intra-panel coherence type is incoherence, all ports of the panel use different precoding matrices, that is, the number of the TPMI is the same as the number of ports. In a case where the intra-panel coherence type is partial coherence, coherent ports of the panel use a same precoding matrix, and incoherent ports use different precoding matrices.

For example, if the network side apparatus schedules a panel A and a panel B, and the panel A and the panel B are coherent, the user equipment 100 may determine one precoding matrix based on one TPMI, and both all ports of the panel A and all ports of the panel B use the precoding matrix. For example, if the network side apparatus schedules a panel C and a panel D, and the panel C and the panel D are incoherent, and the intra-panel coherence type of the panel C is full coherence, and the intra-panel coherence type of the panel D is incoherence, and the panel D has 2 ports, the user equipment may determine 3 precoding matrices based on 3 TPMIs, where all ports of the panel C use a precoding matrix 1, and 2 ports of the panel D use a precoding matrix 2 and a precoding matrix 3, respectively. For example, if the network side apparatus schedules a panel E and a panel F, the panel E and the panel F are incoherent, the intra-panel coherence type of the panel E is full coherence, the intra-panel coherence type of the panel F is partial coherence, and the panel F has four ports, where a port a and a port b are coherent, the user equipment may determine four precoding matrices based on four TPMIs, where all ports of the panel E use a precoding matrix 1, a port a and a port b of the panel F use a precoding matrix 2, a port c of the panel F uses a precoding matrix 3, and a port d of the panel F uses a precoding matrix 4.

Here, the network side apparatus may determine a coherence situation between various panels, for example, by using the inter-panel coherence type in the beam quality information, and determine a coherence situation between ports of each panel by using the intra-panel coherence type in the panel information, thereby determining the number of the precoding matrices required for each panel.

As described above, according to the embodiments of the present disclosure, the user equipment 100 may determine the precoding matrix used by each port of the scheduled multiple antenna panels through the uplink scheduling information of the network side apparatus.

As described above, details of the network side apparatus simultaneously scheduling a plurality of panels of the user equipment 100 are provided according to the present disclosure, so that the network side apparatus may simultaneously schedule a plurality of panels by using the uplink scheduling information, and configure precoding matrices for the plurality of panels.

It can be seen that according to the embodiments of the present disclosure, regardless of whether the user capability value sets are the same or different, the user equipment 100 may report the panel to the network side apparatus, that is, there is no restriction on scheduling a plurality of panels at the network side. In addition, two user capability values including the number of SRS ports and the intra-panel coherence type in the user capability value set are defined in the present disclosure. Furthermore, the network side apparatus is required to provide feedback on the beam quality information sent by the user equipment 100, and the details of sending feedback information by the network side apparatus are provided in the present disclosure, so as to improve the reliability of the beam quality information. In addition, the details of the network side apparatus simultaneously scheduling a plurality of panels of the user equipment 100 are provided in the present disclosure, so that the network side apparatus can simultaneously schedule a plurality of panels by using uplink scheduling information and configure precoding matrices for the plurality of panels. In summary, the uplink transmission process of a plurality of panels of the user equipment 100 is optimized according to the present disclosure.

### <3. Configuration Examples of Network Side Apparatus>

FIG. 6 is a block diagram showing of a structure of electronic apparatus 600 as network side apparatus in a wireless communication system according to an embodiment of the present disclosure. The electronic apparatus 600 herein may be, for example, base station equipment.

As shown in FIG. 6, the electronic apparatus 600 may include a communication unit 610 and a determination unit 620.

Here, each unit of the electronic apparatus 600 may be included in processing circuitry. It should be noted that the electronic apparatus 600 may include one or more processing circuitry. Furthermore, the processing circuitry may include various discrete functional units to perform various different functions and/or operations. It should be noted that these functional units may be physical entities or logical entities, and units with different names may be implemented by the same physical entity.

According to the embodiment of the present disclosure, the electronic apparatus 600 may receive panel information from the user equipment via the communication unit 610. The user equipment here may be user equipment within a service coverage of the electronic apparatus 600.

According to the embodiment of the present disclosure, the determination unit 620 may determine the user capability value set for each of the plurality of panels of the user equipment based on the panel information, where the user capability values in the user capability value set of different panels are the same or different.

As described above, according to the embodiment of the present disclosure, the user capability values in the user capability value sets of different panels in the panel information are the same or different. That is, according to the present disclosure, the restriction on the user equipment that is not allowed to report two panels with the same user capability value is eliminated, that is, the restriction on uplink transmission of a plurality of panels is eliminated, so that the user equipment can report any panel, and the electronic apparatus 600 can schedule any panel, thereby optimizing the uplink transmission process of the plurality of panels of the user equipment.

According to the embodiment of the present disclosure, the determination unit 620 may determine one or more user capability values included in the user capability value set based on the user capability value set. Here, the user capability value may include the intra-panel coherence type, the intra-panel coherence type represents a coherence situation among multiple ports of a panel. The coherence situation among the multiple ports of the panel includes full coherence, partial coherence, and incoherence. That is, the determination unit 620 may determine the intra-panel coherence type of each panel based on the panel information from the user equipment, that is, full coherence, partial coherence, and incoherence.

According to the embodiment of the present disclosure, in a case where multiple ports of the panel are partially coherent, the coherence situation among the multiple ports of the panel further includes partially coherent ports. That is, in a case where the intra-panel coherence type is partial coherence, the determination unit 620 may further determine coherent ports.

According to the embodiment of the present disclosure, the user capability value may further include the number of SRS ports, that is, the determination unit 620 may determine the number of SRS ports for each panel based on the panel information from the user equipment. That is, the user capability value set of each panel may include two user capability values the number of SRS ports, and the intra-panel coherence type.

According to the embodiment of the present disclosure, the electronic apparatus 600 may perform RRC configuration on the user equipment and send the RRC configuration information to the user equipment. In addition, the electronic apparatus 600 may further send the reference signal to the user equipment for measuring channel quality of each beam of each panel.

According to the embodiment of the present disclosure, the electronic apparatus 600 may further receive beam quality information for each panel from the user equipment via the communication unit 610.

According to the embodiment of the present disclosure, the determination unit 620 may determine a preferred beam of the panel based on the beam quality information.

According to the embodiment of the present disclosure, the beam quality information of each panel may include panel indication information and beam indication information, and the determination unit 620 may determine the preferred beam of each panel based on the panel indication information and the beam indication information in the beam quality information. Furthermore, since the panel and the user capability value set are in one-to-one correspondence, the panel indication information may be represented by identification information of the user capability value set (UE capability value set ID), so that the determination unit 620 may determine a panel based on the identification information of the user capability value set. In addition, since a downlink reference signal of the network side apparatus and the beam are in one-to-one correspondence, the beam indication information may be represented by CRI or SSBRI, so that the determination unit may determine a beam based on CRI or SSBRI.

According to the embodiment of the present disclosure, the determination unit 620 may further determine the channel quality information of the preferred beam of the panel based on the beam quality information, such as L1-SINR or L1-RSRP.

According to the embodiment of the present disclosure, the determination unit 620 may determine an inter-panel coherence type of the panel based on the beam quality information. The inter-panel coherence type represents a coherence situation between the panel and other panels, and the coherence situation between the panel and the other panels includes incoherence and coherence. Furthermore, in a case where the panel is coherent with other panels, the coherence situation between the panel and the other panels further includes information on the other panels coherent with the panel. That is, the determination unit 620 may determine whether there is other panel coherent with the panel based on the inter-panel coherence type; and may further determine the other panel coherent with the panel in a case where there is other panel coherent with the panel. For example, the determination unit 620 may determine other panel based on the identification information of the user capability value set.

According to the embodiment of the present disclosure, as shown in FIG. 6, the electronic apparatus 600 may further include a generation unit 630. The generation unit 630 is configured to generate feedback information for the beam quality information. Furthermore, the electronic apparatus 600 may send feedback information to the user equipment via the communication unit 610.

According to the embodiment of the present disclosure, in a case where the user equipment sends the beam quality information through PUCCH, the electronic apparatus 600 may carry the feedback information by using a DCI format 0 or DCI format 2. The feedback information includes ACK and NACK. That is, in a case where the beam quality information is successfully received by the electronic apparatus 600, the generation unit 630 generates ACK. In a case where the beam quality information fails to be successfully received by the electronic apparatus 600, the generation unit 630 generates NACK.

According to the embodiment of the present disclosure, the electronic apparatus 600 may send feedback information by using the DCI format 0, such as DCI format 0_1. Specifically, the electronic apparatus 600 may indicate whether the information is feedback for PUSCH, PUCCH, or PUSCH and PUCCH based on a DFI flag, and generate a HARQ-ACK bitmap of PUCCH or a HARQ-ACK bitmap of PUSCH and PUCCH based on the feedback information. Specifically, as shown in FIG. 2, the DCI format 0_1 includes identification of DCI format, carrier indication, the DFI flag, the HARQ-ACK bitmap, TPC, and the reserved bit. In a case where the DFI flag is 01, the HARQ-ACK bitmap represents the HARQ-ACK bitmap for PUSCH, and TPC represents TPC for PUSCH. In a case where the DFI flag is 10, the HARQ-ACK bitmap represents the HARQ-ACK bitmap for PUCCH, and TPC represents TPC for PUCCH. In a case where the DFI flag is 11, the HARQ-ACK bitmap represents the HARQ-ACK bitmap for PUSCH and PUCCH, and TPC represents TPC for PUSCH and PUCCH. In a case where the DFI flag is 00, there is no HARQ-ACK bitmap, TPC, and reserved bit information, indicating uplink grant information.

As described above, in a case where the user equipment sends the beam quality information by using PUCCH, and the electronic apparatus 600 sends ACK or NACK, the electronic apparatus 600 may carry feedback information by reusing the DCI format 0_1, and the DCI format 0_1 is only slightly modified for carrying the feedback information.

According to the embodiment of the present disclosure, the electronic apparatus 600 may send the feedback information by using the DCI format 2, such as DCI format 2_x. Specifically, the generation unit may determine HARQ-ACK codebooks for all PUCCH resources based on the feedback information and the PUCCH resources that the user equipment sends the beam quality information. That is, the HARQ-ACK codebooks for all

PUCCH resources may include feedback information from multiple user equipments served by the electronic apparatus 600. Specifically, as shown in FIG. 3, the DCI format 2_x includes PUCCH resources 1 to N, and HARQ-ACK codebooks for the PUCCH resources 1 to N.

As described above, in a case where the user equipment sends the beam quality information by using PUCCH, and the electronic apparatus 600 sends ACK or NACK, the electronic apparatus 600 may design a new DCI format 2_x to carry the feedback information. Furthermore, the electronic apparatus 600 may assign a new RNTI (Radio Network Temporary Identity) to scramble the newly designed DCI format 2_x.

According to the embodiment of the present disclosure, in a case where the user equipment sends the beam quality information through PUCCH, the electronic apparatus 600 may carry the feedback information by using the DCI format 1, and the feedback information includes NACK. That is, in a case where the beam quality information is successfully received by the electronic apparatus 600, no feedback information is sent; and in a case where the beam quality information fails to be successfully received by the electronic apparatus 600, the generation unit 630 generates NACK.

According to the embodiment of the present disclosure, the electronic apparatus 600 may represent NACK feedback information by using a specific value of one or more fields in the DCI format 1_1 or the DCI format 1_2. For example, the electronic apparatus 600 may represent NACK by using one or more specific values of the RV field, the MCS field, and the FDRA field. As a non-limiting example, all values of the RV field are 1, all values of the MCS field are 1, and all values of the FDRA field are 0, which represents NACK. Specifically, as shown in FIGS. 4 and 5, the DCI format 1_1 and the DCI format 1_2 include identification of the DCI format, carrier indication, the RV field, the MCS field, the FDRA field, and the PUCCH resource indication. In a case where all values of the RV field are 1, all values of the MCS field are 1, and all values of the FDRA field are 0, which represents NACK information. In addition, the electronic apparatus 600 may further indicate PUCCH that has not been successfully decoded by using a field of the PUCCH resource indication.

As described above, according to the embodiment of the present disclosure, in a case where the user equipment send the beam quality information by using PUCCH, and the electronic apparatus 600 only provides feedback on NACK without ACK, the electronic apparatus 600 may carry the feedback information by reusing the DCI format 1.

According to the embodiment of the present disclosure, in a case where the user equipment sends the beam quality information through PUSCH, the electronic apparatus 600 may indicate the feedback information by using content of the content of the NDI field in DCI format 0. For example, the electronic apparatus 600 may represent ACK or NACK by using the content of the NDI field in the uplink grant in the DCI format 0_0 or the DCI format 0)1.In a case where the beam quality information is successfully received by the electronic apparatus 600, the value of the NDI field may be set to 1. In a case where the beam quality information fails to be successfully received by the electronic apparatus 600, the value of the NDI field may be set to 0. Furthermore, the electronic apparatus 600 may determine an NDI corresponding to the sent beam quality information based on the HARQ process identification information (HARQ process ID).

As described above, according to the embodiment of the present disclosure, in a case where the user equipment sends the beam quality information by using PUSCH, the electronic apparatus 600 may carry the feedback information through the identification information and NDI field of the HARQ process in the DCI format 0.

As described above, that electronic apparatus 600 is required to provide feedback on the beam quality information sent by the user equipment in the present disclosure. Furthermore, details of sending the feedback information by the electronic apparatus 600 are provided according to the present disclosure, so as to improve the reliability of the beam quality information.

According to the embodiment of the present disclosure, as shown in FIG. 6, the electronic apparatus 600 may further include a panel determination unit 640. The panel determination unit 640 is configured to determine a plurality of panels for uplink transmission for the user equipment. Furthermore, the generation unit 630 may generate uplink scheduling information, and the electronic apparatus 600 may send the uplink scheduling information to the user equipment via the communication unit 610. Here, the electronic apparatus 600 may send the uplink scheduling information through the DCI format 0.

According to the embodiment of the present disclosure, the uplink scheduling information may include multiple SRIs to indicate a plurality of panels scheduled for the user equipment. That is, the electronic apparatus 600 may determine multiple beams on to-be-scheduled a plurality of panels. Since SRI has a one-to-one correspondence with the uplink beam, multiple beams may be indicated by multiple SRIs, thereby indicating a plurality of panels.

According to the embodiment of the present disclosure, the uplink scheduling information may include one SRI for indicating multiple beams on a plurality of panels scheduled for the user equipment. For example, a mapping relationship between a beam combination and the SRI may be preset between the user equipment 100 and the network side apparatus. That is, various combinations of beams on different panels may be listed, and each combination has a mapping relationship with an SRI. In this way, the electronic apparatus 600 may determine an SRI corresponding to a scheduled beam combination, so that the SRI is included in the uplink scheduling information.

According to the embodiment of the present disclosure, as shown in FIG. 6, the electronic apparatus 600 may further include a precoding matrix determination unit 650. The precoding matrix determination unit 650 is configured to determine a precoding matrix for each port of the scheduled a plurality of panels.

According to the embodiment of the present disclosure, in a case where a plurality of panels scheduled by electronic apparatus 600 are coherent, the plurality of panels may use a same precoding matrix. Therefore, the precoding matrix determination unit 650 may determine one precoding matrix to serve as a precoding matrix for the plurality of panels, and the generation unit 630 may indicate the precoding matrix with one TPMI and cause the TPMI to be included in the uplink scheduling information.

According to the embodiment of the present disclosure, in a case where a plurality of panels scheduled by electronic apparatus 600 are incoherent, the plurality of panels may use different precoding matrices. The precoding matrix determination unit 650 may further determine the number of the precoding matrices for each panel based on the intra-panel coherence type of each scheduled panel. That is, in a case where the intra-panel coherence type is full coherence, all ports of the panel use a same precoding matrix, that is, the number of the precoding matrix for the panel is 1. In a case where the intra-panel coherence type is incoherence, all ports of the panel use different precoding matrices, that is, the number of the precoding matrix for the panel is the same as the number of the ports. In a case where the intra-panel coherence type is partial coherence, coherent ports of the panel use a same precoding matrix, and incoherent ports use different precoding matrices. Furthermore, after the precoding matrix determination unit 650 determines the number of the precoding matrix for each panel, the generation unit 630 may indicate multiple precoding matrices with the number of TPMIs corresponding to the number of the precoding matrix, and control the multiple TPMIs to be included in the uplink scheduling information.

Here, the electronic apparatus 600 may determine a coherence situation between various panel by the inter-panel coherence type in the beam quality information, and determine a coherence situation between ports of each panel by the intra-panel coherence type in the panel information, thereby determining the number of to-be-sent TPMIs.

As described above, details of the electronic apparatus 600 scheduling a plurality of panels of the user equipment simultaneously are provided in the present disclosure, so that the electronic apparatus 600 schedule a plurality of panels simultaneously by using the uplink scheduling information, and configure precoding matrices for the plurality of panels.

It can be seen that according to the embodiment of the present disclosure, regardless of whether the user capability value sets are the same, the user equipment may report the panel to the electronic apparatus 600, that is, there is no restriction on scheduling a plurality of panels by the electronic apparatus 600. In addition, two user capability values including the number of SRS ports and the intra-panel coherence type in the user capability value set are defined in the present disclosure. Furthermore, the electronic apparatus 600 is required to provide feedback on the beam quality information sent by the user equipment, and the details of sending feedback information by the electronic apparatus 600 are provided in the present disclosure, so as to improve the reliability of the beam quality information. In addition, the details of the electronic apparatus 600 simultaneously scheduling a plurality of panels of the user equipment 100 are provided in the present disclosure, so that the electronic apparatus 600 can simultaneously schedule a plurality of panels by using uplink scheduling information and configure precoding matrices for the plurality of panels. In summary, the uplink transmission process of a plurality of panels of the user equipment is optimized according to the present disclosure.

### <4. Embodiments of Method>

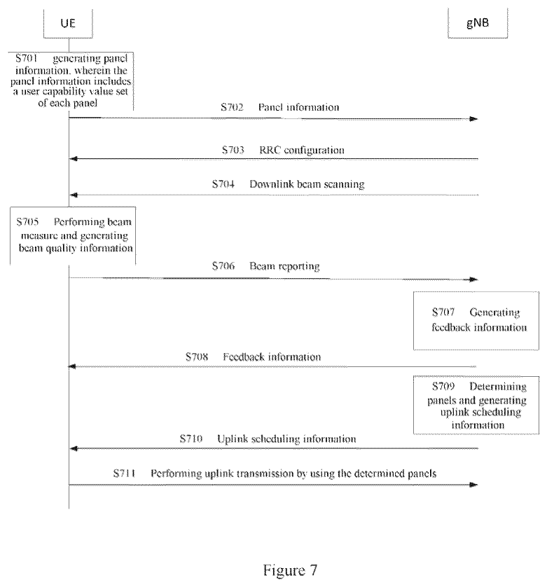

FIG. 7 is a signaling flowchart of a process of scheduling a plurality of panels of user equipment according to an embodiment of the present disclosure. In FIG. 7, UE may be implemented by the user equipment 100, and gNB may be implemented by the electronic apparatus 600. As shown in FIG. 7, in step S701, UE generates panel information, and the panel information includes a user capability value set of each panel. In step S702, UE sends the panel information to gNB. In step S703, gNB performs RRC configuration on UE. In step S704, gNB performs downlink beam scanning on UE. In step S705, UE measures the channel quality of each beam and generates beam quality information. In step S706, UE sends the generated beam quality information to gNB. In step S707, gNB generates feedback information. In step S708, gNB sends the feedback information to UE. In step S709, gNB determines a plurality of panels scheduled for UE and a precoding matrix of each port of each panel, and generates uplink scheduling information. In step S710, gNB sends the uplink scheduling information to UE. In step S711, UE performs uplink transmission by using panels scheduled by gNB. As a result, gNB can schedule a plurality of panels for uplink transmission of UE.

Next, a wireless communication method performed by the user equipment 100 in a wireless communication system according to an embodiment of the present disclosure is described in detail.

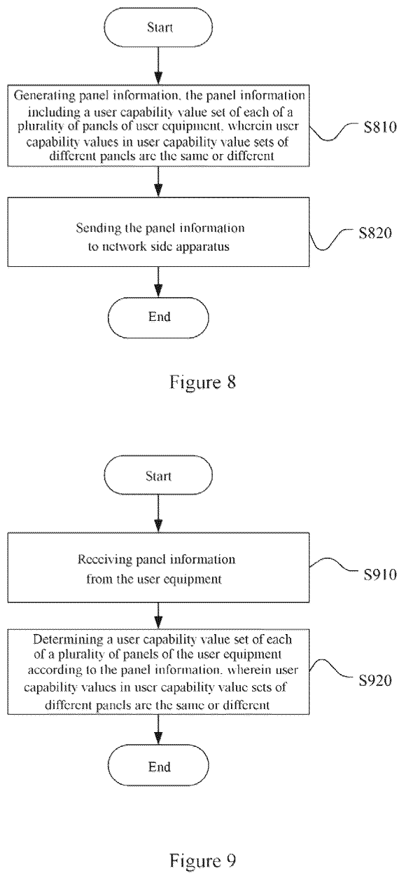

FIG. 8 is a flowchart illustrating a wireless communication method performed by user equipment 100 according to an embodiment of the present disclosure.

As shown in FIG. 8, in step S810, panel information is generated, the panel information includes a user capability value set of each of a plurality of panels of the user equipment 100, where user capability values in user capability value sets of different panels are the same or different.

Next, in step S820, the panel information is sent to network side apparatus.

Preferably, the user capability value includes an intra-panel coherence type. The intra-panel coherence type represents a coherence situation among multiple ports of a panel, and the coherence situation among the multiple ports of the panel includes full coherence, partial coherence, and incoherence.

Preferably, in a case where multiple ports of the panel are partial coherence, the coherence situation among the multiple ports of the panel further includes partially coherent ports.

Preferably, the wireless communication method further includes: measuring channel quality of each beam according to a reference signal from the network side apparatus; generate beam quality information for each panel, where the beam quality information includes a preferred beam of the panel and an inter-panel coherence type of the panel, and the inter-panel coherence type represents a coherence situation between the panel and other panels, the coherence situation between the panel and the other panels includes incoherence and coherence; and send beam quality information to the network side apparatus.

Preferably, in a case where the panel is coherent with other panels, the coherence situation between the panel and the other panels further includes information on the other panels coherent with the panel.

Preferably, the wireless communication method further includes: receiving feedback information for the beam quality information from the network side apparatus.

Preferably, the wireless communication method further includes: sending the beam quality information by using PUCCH; and determining the feedback information by using a DCI format 0 or a DCI format 2, where the feedback information includes ACK and NACK.

Preferably, the wireless communication method further includes: sending the beam quality information by using PUCCH; and determining the feedback information by using a DCI format 1, where the feedback information includes NACK.

Preferably, the wireless communication method further includes: sending the beam quality information by using PUCCH; and determining the feedback information by using content of a new data indicator NDI field in a DCI format 0.

Preferably, the wireless communication method further includes: receiving uplink scheduling information from the network side apparatus, where the uplink scheduling information includes one or more detection reference signal SRS resource indicators SRIs; and determining a plurality of panels for uplink transmission based on the one or more SRIs.

Preferably, the uplink scheduling information further includes one transmission precoding matrix indication TPMI, and the wireless communication method further includes: determining a precoding matrix of multiple coherent panels based on the TPMI.

Preferably, the uplink scheduling information further includes multiple TPMIs, and the wireless communication method further includes: determining precoding matrices of multiple incoherent panels based on the multiple TPMIs.

According to the embodiments of the present disclosure, a subject that performs the above method may be the user equipment 100 according to the embodiments of the present disclosure, and thus all the foregoing embodiments of the user equipment 100 are applicable herein.

Next, a wireless communication method performed by an electronic apparatus 600 as a network side apparatus in a wireless communication system according to an embodiment of the present disclosure is described in detail.

FIG. 9 is a flowchart illustrating a wireless communication method performed by electronic apparatus 600 as network side apparatus in a wireless communication system according to an embodiment of the present disclosure.

As shown in FIG. 9, in step S910, panel information is received from the user equipment.

Next, in step S920, a user capability value set of each of the plurality of panels of the user equipment is determined according to the panel information, where user capability values in user capability value sets of different panels are the same or different.

Preferably, the user capability value includes an intra-panel coherence type, the intra-panel coherence type represents a coherence situation among multiple ports of a panel, and the coherence situation among the multiple ports of the panel includes full coherence, partial coherence, and incoherence.

Preferably, in a case where the multiple ports of the panel are partially coherent, the coherence situation among the multiple ports of the panel further includes partially coherent ports.

Preferably, the wireless communication method further includes receiving beam quality information for each panel from the user equipment; and determining a preferred beam of the panel and an inter-panel coherence type of the panel based on the beam quality information, where the inter-panel coherence type represents a coherence situation between the panel and other panels, and the coherence situation between the panel and the other panels includes incoherence and coherence.

Preferably, in a case where the panel is coherent with other panels, the coherence situation between the panel and the other panels further includes information on the other panels coherent with the panel.

Preferably, the wireless communication method further includes: generating feedback information for the beam quality information; and sending the feedback information to the user equipment.

Preferably, the wireless communication method further includes: receiving the beam quality information by using PUCCH; and carrying the feedback information by using a DCI format 0 or a DCI format 2, the feedback information including ACK and NACK.

Preferably, the wireless communication method further includes: receiving the beam quality information by using PUCCH; and carrying the feedback information by using a DCI format 0, the feedback information including NACK.

Preferably, the wireless communication method further includes: receiving the beam quality information by using PUCCH; and indicating the feedback information by using content of a new data indicator NDI field in a DCI format 0.

Preferably, the wireless communication method further includes: determining a plurality of panels for uplink transmission for the user equipment; generating uplink scheduling information, the uplink scheduling information including one or more detection reference signal SRS resource indicators SRIs for indicating the plurality of panels; and sending the uplink scheduling information to the user equipment.

Preferably, in a case where the plurality of panels for uplink transmission are coherent, the uplink scheduling information further includes one transmission precoding matrix indication TPMI for the user equipment to determine a precoding matrix of multiple coherent panels; and in a case where the plurality of panels for uplink transmission are incoherent, the uplink scheduling information further includes multiple TPMIs for the user equipment to determine precoding matrices of multiple incoherent panels.

According to the embodiments of the present disclosure, a subject that performs the above method may be the electronic apparatus 600 according to the embodiments of the present disclosure, and thus all the foregoing embodiments of the electronic apparatus 600 are applicable herein.

### <5. Application Examples>

The technology of the present disclosure may be applied to various products.

For example, the network side apparatus may be implemented as any type of base station equipment, such as a macro eNB and a small eNB, or may be implemented as any type of gNB (a base station in a 5G system). The small eNB may be an eNB such as a pico eNB, a micro eNB and a home (femto) eNB that covers a cell smaller than a macro cell, and further implemented as gNB. Alternatively, the base station may also be implemented as any other type of base station, such as a NodeB and a base transceiver station (BTS). The base station may include a body (also referred to as base station equipment) configured to control wireless communications; and one or more remote radio heads (RRHs) arranged in a different position from the body.

The user equipment may be implemented as a mobile terminal (such as a smartphone, a tablet personal computer (PC), a notebook PC, a portable game terminal, a portable/dongle type mobile router, and a digital camera), or a vehicle-mounted terminal (such as a car navigation apparatus). The user equipment may also be implemented as a terminal (also referred to as a machine-type communication (MTC) terminal) that performs machine-to-machine (M2M) communication. Furthermore, the user equipment may be a wireless communication module (such as an integrated circuitry module including a single die) mounted on each of the user equipment described above.

### <Application Example Regarding Base Station>

### (First Application Example)

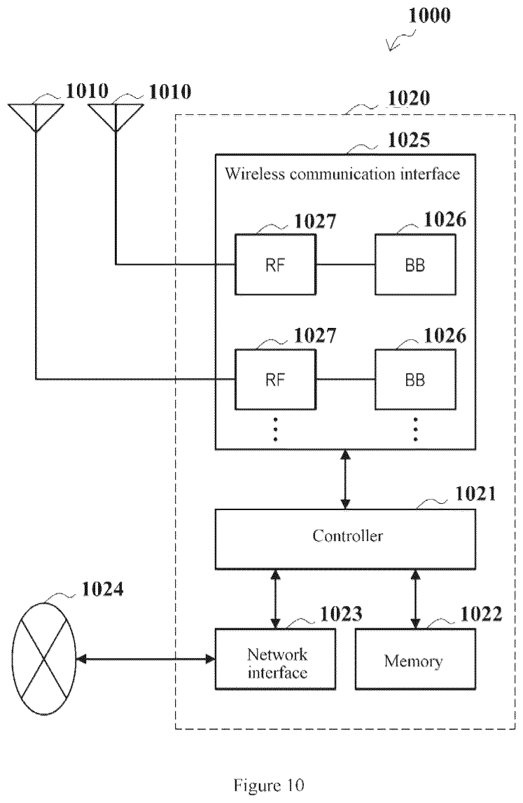

FIG. 10 is a block diagram illustrating a first example of a schematic configuration of a gNB to which the technology of the present disclosure may be applied. The gNB 1000 includes one or more antennas 1010 and base station equipment 1020. The base station equipment 1020 and each antenna 1010 may be connected to each other via an RF cable.

Each of the antennas 1010 includes one or more antenna elements (such as multiple antenna elements included in a multiple-input multiple-output (MIMO) antenna), and are used for transmitting and receiving a wireless signal by the base station equipment 1020. As shown in FIG. 10, the gNB 1000 may include the multiple antennas 1010. For example, the multiple antennas 1010 may be compatible with multiple frequency bands used by the gNB 1000. Although FIG. 10 shows an example in which the gNB 1000 includes multiple antennas 1010, the gNB 1000 may include a single antenna 1010.

The base station equipment 1020 includes a controller 1021, a memory 1022, a network interface 1023 and a wireless communication interface 1025.

The controller 1021 may be for example a CPU or a DSP and operate various functions of higher layers of the base station equipment 1020. For example, the controller 1021 generates a data packet from data in signals processed by the wireless communication interface 1025, and transfers the generated packet via the network interface 1023. The controller 1021 may bundle data from multiple baseband processors to generate a bundled packet and transmit the generated bundled packet. The controller 1021 may have a logical function of performing the following control, such as radio resource control, radio bearer control, mobility management, admission control, and scheduling. The control may be performed in conjunction with an adjacent gNB or a core network node. The memory 1022 includes RAM and ROM, and stores programs executed by the controller 1021 and various types of control data (such as a terminal list, transmission power data and scheduling data).

The network interface 1023 is configured to connect the base station equipment 1020 to a communication interface of the core network 1024. The controller 1021 may communicate with a core network node or another gNB via the network interface 1023. In this case, the gNB 1000 and the core network node or the other gNB may be connected to each other via a logical interface (such as an S1 interface and an X2 interface). The network interface 1023 may also be a wired communication interface or a wireless communication interface for a wireless backhaul. In a case where the network interface 1023 is a wireless communication interface, the network interface 1023 may use a higher frequency band for wireless communication than a frequency band used by the wireless communication interface 1025.

The wireless communication interface 1025 supports any cellular communication scheme (such as Long Term Evolution (LTE) and LTE-advanced), and provides wireless connection to a terminal located in a cell of the eNB 1000 via the antenna 1010. The wireless communication interface 1025 may generally include a BB processor 1026 and an RF circuit 1027. The BB processor 1026 may perform for example encoding/decoding, modulating/demodulating and multiplexing/de-multiplexing, and various types of signal processing of layers (such as L1, medium access control (MAC), radio link control (RLC) and packet data convergence protocol (PDCP)). Instead of the controller 1021, the BB processor 1026 may have a part or all of the logic functions described above. The BB processor 1026 may be a memory storing communication control programs, or a module including a processor which is configured to execute the programs and a related circuit. Update of the programs may change the function of the BB processor 1026. The module may be a card or blade inserted into a slot of the base station equipment 1020. Alternatively, the module may be a chip mounted on a card or blade. The RF circuit 1027 may include, for example, a mixer, a filter and an amplifier, and transmit and receive a wireless signal via the antenna 1010.

As shown in FIG. 10, the wireless communication interface 1025 may include multiple BB processors 1026. For example, the multiple BB processors 1026 may be compatible with multiple frequency bands used by the gNB 1000. As shown in FIG. 10, the wireless communication interface 1025 may include multiple RF circuits 1027. For example, the multiple RF circuits 1027 may be compatible with multiple antenna elements. Although

FIG. 10 shows an example in which the wireless communication interface 1025 includes the multiple BB processors 1026 and the multiple RF circuits 1027, the wireless communication interface 1025 may also include a single BB processor 1026 and a single RF circuit 1027.

### (Second Application Example)

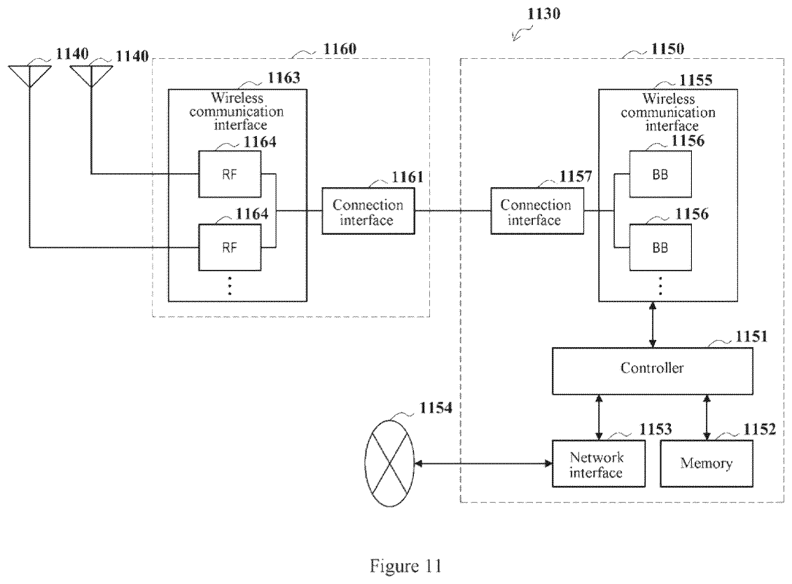

FIG. 11 is a block diagram illustrating a second example of a schematic configuration of a gNB to which the technology of the present disclosure may be applied. A gNB 1130 includes one or more antennas 1140, base station equipment 1150 and an RRH 1160. Each of the antennas 1140 and the RRH 1160 may be connected to each other via an RF cable. The base station equipment 1150 and the RRH 1160 may be connected to each other via a high-speed line such as a fiber cable.

Each of the antennas 1140 includes a single or multiple antenna elements (such as multiple antenna elements included in an MIMO antenna), and is used for transmitting and receiving a wireless signal by the RRH 1160. As shown in FIG. 11, the gNB 1130 may include the multiple antennas 1140. For example, the multiple antennas 1140 may be compatible with multiple frequency bands used by the gNB 1130. Although FIG. 11 illustrates an example in which the gNB 1130 includes multiple antennas 1140, the gNB 1130 may include a single antenna 1140.

The base station equipment 1150 includes a controller 1151, a memory 1152, a network interface 1153, a wireless communication interface 1155, and a connection interface 1157. The controller 1151, the memory 1152, and the network interface 1153 are the same as the controller 1021, the memory 1022, and the network interface 1023 described with reference to FIG. 10.

The wireless communication interface 1155 supports any cellular communication solution (such as LTE and LTE-advanced), and provides wireless communication with a terminal located in a sector corresponding to the RRH 1160 via the RRH 1160 and the antenna 1140. The wireless communication interface 1155 may typically include a BB processor 1156 for example. The BB processor 1156 is the same as the BB processor 1026 described with reference to FIG. 10, except that the BB processor 1156 is connected to the RF circuit 1164 of the RRH 1160 via the connection interface 1157. As show in FIG. 11, the wireless communication interface 1155 may include multiple BB processors 1156. For example, the multiple BB processors 1156 may be compatible with multiple frequency bands used by the gNB 1130. Although FIG. 11 shows an example in which the wireless communication interface 1155 includes the multiple BB processors 1156, the wireless communication interface 1155 may include a single BB processor 1156.

The connection interface 1157 is an interface for connecting the base station equipment 1150 (wireless communication interface 1155) to the RRH 1160. The connection interface 1157 may further be a communication module for connecting the base station equipment 1150 (wireless communication interface 1155) to a communication in the above high-speed line of the RRH 1160.

The RRH 1160 includes a connection interface 1161 and a wireless communication interface 1163.

The connection interface 1161 is an interface for connecting the RRH 1160 (the wireless communication interface 1663) to the base station equipment 1150. The connection interface 1161 may be a communication module for the communication in the above high-speed line.

The wireless communication interface 1163 transmits and receives a wireless signal via the antenna 1140. The wireless communication interface 1163 may generally include for example the RF circuit 1164. The RF circuit 1164 may include, for example, a mixer, a filter, and an amplifier, and transmits and receives radio signals via the antenna 1140. The wireless communication interface 1163 may include multiple RF circuits 1164, as illustrated in FIG. 11. For example, the multiple RF circuits 1164 may support multiple antenna elements. Although FIG. 11 shows an example in which the wireless communication interface 1163 includes the multiple RF circuits 1164, the wireless communication interface 1163 may also include a single RF circuit 1164.

In gNB 1000 and gNB 1130 shown in FIGS. 10 and 11, the determination unit 620, the generation unit 630, the panel determination unit 640, and the precoding matrix determination unit 650 described in FIG. 6 may be implemented by the controller 1021 and/or the controller 1151. At least a part of the functions may be implemented by the controller 1021 and the controller 1151. For example, the controller 1021 and/or the controller 1151 may execute corresponding instructions stored in the memory to implement the following functions: selecting and determining the panel information, determining the beam quality information, generating the feedback information, generating the uplink scheduling information, determining panels of the user equipment, and determining a precoding matrix of each panel.

### <Application Example Regarding Terminal Device>

### (First Application Example)

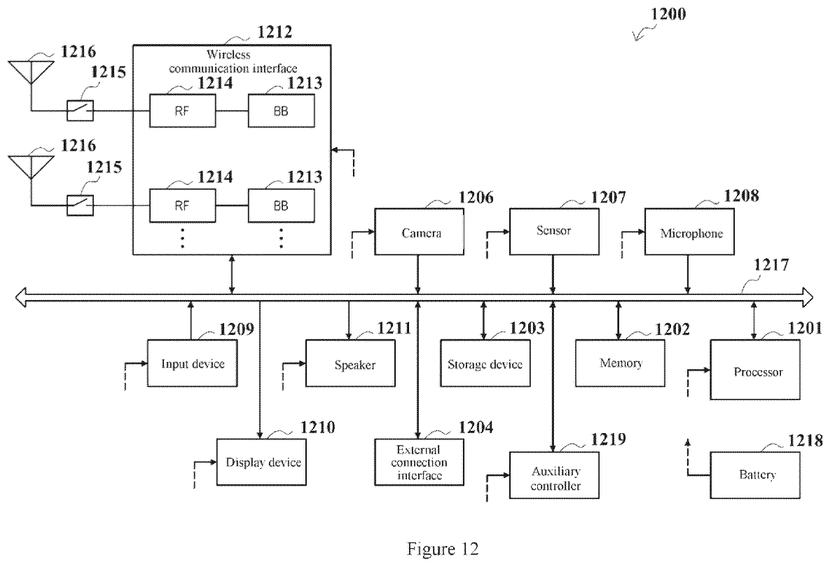

FIG. 12 is a block diagram showing an exemplary configuration of a smartphone 1200 to which the technology according to the present disclosure may be applied. The smartphone 1200 includes a processor 1201, a memory 1202, a storage device 1203, an external connection interface 1204, a camera 1206, a sensor 1207, a microphone 1208, an input device 1209, a display device 1210, a speaker 1211, a wireless communication interface 1212, one or more antenna switches 1215, one or more antennas 1216, a bus 1217, a battery 1218, and an auxiliary controller 1219.

The processor 1201 may be, for example, a CPU or a system on a chip (SoC), and controls functions of an application layer and another layer of the smartphone 1200. The memory 1202 includes a RAM and a ROM, and stores a program executed by the processor 1201 and data. The storage device 1203 may include a storage medium such as a semiconductor memory and a hard disk. The external connection interface 1204 is an interface for connecting an external device (such as a memory card and a universal serial bus (USB) device) to the smartphone 1200.

The camera 1206 includes an image sensor (such as a charge coupled device (CCD) and a complementary metal oxide semiconductor (CMOS)), and generates a captured image. The sensor 1207 may include a group of sensors, such as a measurement sensor, a gyro sensor, a geomagnetism sensor, and an acceleration sensor. The microphone 1208 converts sounds that are inputted to the smartphone 1200 to audio signals. The input device 1209 includes, for example, a touch sensor configured to detect touch onto a screen of the display device 1210, a keypad, a keyboard, a button, or a switch, and receives an operation or information inputted from a user. The display device 1210 includes a screen (such as a liquid crystal display (LCD) and an organic light-emitting diode (OLED) display), and displays an output image of the smartphone 1200. The speaker 1211 converts audio signals that are outputted from the smartphone 1200 to sounds.

The wireless communication interface 1212 supports any cellular communication scheme (such as LTE and LTE-advanced), and performs a wireless communication. The wireless communication interface 1212 may include, for example, a BB processor 1213 and an RF circuit 1214. The BB processor 1213 may perform, for example, encoding/decoding, modulating/demodulating, and multiplexing/de-multiplexing, and perform various types of signal processing for wireless communication. The RF circuit 1214 may include, for example, a mixer, a filter and an amplifier, and transmits and receives wireless signals via the antenna 1216. The wireless communication interface 1212 may be a chip module having the BB processor 1213 and the RF circuit 1214 integrated thereon. As shown in FIG. 12, the wireless communication interface 1212 may include multiple BB processors 1213 and multiple RF circuits 1214. Although FIG. 12 shows the example in which the wireless communication interface 1212 includes the multiple BB processors 1213 and the multiple RF circuits 1214, the wireless communication interface 1212 may also include a single BB processor 1213 or a single RF circuit 1214.

Furthermore, in addition to a cellular communication scheme, the wireless communication interface 1212 may support another type of wireless communication scheme such as a short-distance wireless communication scheme, a near field communication scheme, and a radio local area network (LAN) scheme. In this case, the wireless communication interface 1212 may include the BB processor 1213 and the RF circuit 1214 for each wireless communication scheme.

Each of the antenna switches 1215 switches connection destinations of the antennas 1216 among multiple circuits (such as circuits for different wireless communication schemes) included in the wireless communication interface 1212.

Each of the antennas 1216 includes a single or multiple antenna elements (such as multiple antenna elements included in an MIMO antenna) and is used for the wireless communication interface 1212 to transmit and receive wireless signals. As shown in FIG. 12, the smartphone 1200 may include the multiple antennas 1216. Although FIG. 12 shows the example in which the smartphone 1200 includes the multiple antennas 1216, the smartphone 1200 may also include a single antenna 1216.

Furthermore, the smartphone 1200 may include the antenna 1216 for each wireless communication scheme. In this case, the antenna switches 1215 may be omitted from the configuration of the smartphone 1200.

The bus 1217 connects the processor 1201, the memory 1202, the storage device 1203, the external connection interface 1204, the camera 1206, the sensor 1207, the microphone 1208, the input device 1209, the display device 1210, the speaker 1211, the wireless communication interface 1212, and the auxiliary controller 1219 to each other. The battery 1218 supplies power to blocks of the smartphone 1200 shown in FIG. 12 via feeder lines that are partially shown as dashed lines in FIG. 12. The auxiliary controller 1219, operates a minimum necessary function of the smartphone 1200, for example, in a sleep mode.

In the smartphone 1200 shown in FIG. 12, the generation unit 110, the coherence type determination unit 130, the measurement unit 140, the selection unit 150, the decoding unit 160, the panel determination unit 170, and the precoding matrix determination unit 180 described in FIG. 1 may be implemented by the processor 1201 or the auxiliary controller 1219. At least a part of the functions may also be implemented by the processor 1201 or the auxiliary controller 1219. For example, the processor 1201 or the auxiliary controller 1219 may execute instructions stored in the memory 1202 or the storage device 1203 to implement the following functions: generating the panel information, generating the beam quality information, determining the intra-panel coherence type, determining the inter-panel coherence type, measuring the channel quality, selecting the preferred beam, decoding the feedback information, determining a panel scheduled by the network side apparatus, and determining the precoding matrix of the panel.

### (Second Application Example)

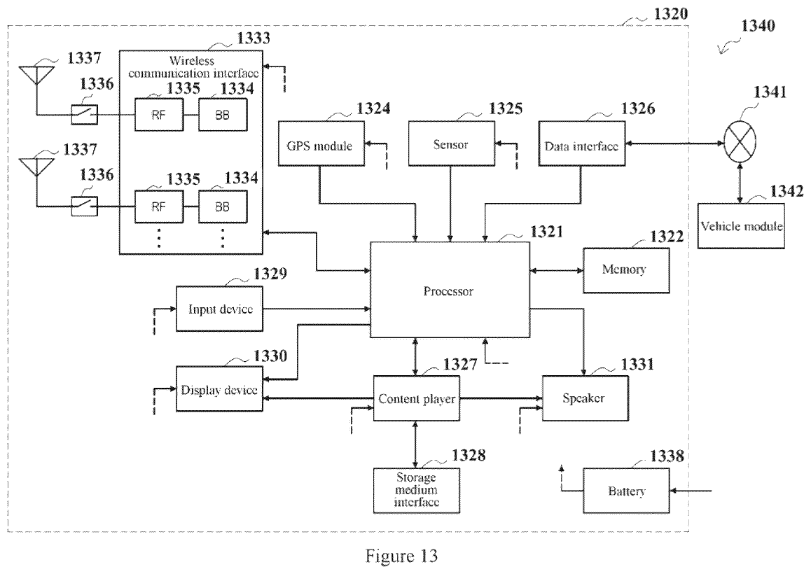

FIG. 13 is a block diagram showing an example of an exemplary configuration of a car navigation apparatus 1320 to which the technology according to the present disclosure may be applied. The car navigation apparatus 1320 includes a processor 1321, a memory 1322, a global positioning system (GPS) module 1324, a sensor 1325, a data interface 1326, a content player 1327, a storage medium interface 1328, an input device 1329, a display device 1330, a speaker 1331, a wireless communication interface 1333, one or more antenna switches 1336, one or more antennas 1337, and a battery 1338.

The processor 1321 may be, for example a CPU or a SoC, and controls a navigation function and additional function of the car navigation apparatus 1320. The memory 1322 includes RAM and ROM, and stores a program that is executed by the processor 1321 and data.

The GPS module 1324 determines a position (such as latitude, longitude and altitude) of the car navigation apparatus 1320 by using GPS signals received from a GPS satellite. The sensor 1325 may include a group of sensors such as a gyro sensor, a geomagnetic sensor and an air pressure sensor. The data interface 1326 is connected to, for example, a vehicle-mounted network 1341 via a terminal that is not shown, and acquires data (such as vehicle speed data) generated by the vehicle.

The content player 1327 reproduces content stored in a storage medium (such as a CD and a DVD) that is inserted into the storage medium interface 1328. The input device 1329 includes, for example, a touch sensor configured to detect touch onto a screen of the display device 1330, a button, or a switch, and receives an operation or information inputted from a user. The display device 1330 includes a screen such as an LCD or OLED display, and displays an image of the navigation function or content that is reproduced. The speaker 1331 outputs a sound for the navigation function or the content that is reproduced.

The wireless communication interface 1333 supports any cellular communication scheme (such as LTE and LTE-Advanced), and performs wireless communication. The wireless communication interface 1333 may typically include, for example, a BB processor 1334 and an RF circuit 1335. The BB processor 1334 may perform, for example, encoding/decoding, modulating/demodulating and multiplexing/demultiplexing, and perform various types of signal processing for wireless communication. The RF circuit 1335 may include, for example, a mixer, a filter and an amplifier, and transmits and receives wireless signals via the antenna 1337. The wireless communication interface 1333 may also be a chip module having the BB processor 1334 and the RF circuit 1335 integrated thereon. As shown in FIG. 13, the wireless communication interface 1333 may include multiple BB processors 1334 and multiple RF circuits 1335. Although FIG. 13 shows the example in which the wireless communication interface 1333 includes the multiple BB processors 1334 and the multiple RF circuits 1335, the wireless communication interface 1333 may also include a single BB processor 1334 and a single RF circuit 1335.

Furthermore, in addition to a cellular communication scheme, the wireless communication interface 1333 may support another type of wireless communication scheme such as a short-distance wireless communication scheme, a near field communication scheme, and a wireless LAN scheme. In this case, the wireless communication interface 1333 may include the BB processor 1334 and the RF circuit 1335 for each wireless communication scheme.

Each of the antenna switches 1336 switches connection destinations of the antennas 1337 among multiple circuits (such as circuits for different wireless communication schemes) included in the wireless communication interface 1333.

Each of the antennas 1337 includes a single or multiple antenna elements (such as multiple antenna elements included in an MIMO antenna), and is used by the wireless communication interface 1333 to transmit and receive wireless signals. As shown in FIG. 13, the car navigation apparatus 1320 may include the multiple antennas 1337. Although FIG. 13 shows the example in which the car navigation apparatus 1320 includes the multiple antennas 1337, the car navigation apparatus 1320 may also include a single antenna 1337.

Furthermore, the car navigation apparatus 1320 may include the antenna 1337 for each wireless communication scheme. In this case, the antenna switches 1336 may be omitted from the configuration of the car navigation apparatus 1320.

The battery 1338 supplies power to the blocks of the car navigation apparatus 1320 shown in FIG. 13 via feeder lines that are partially shown as dash lines in FIG. 13. The battery 1338 accumulates power supplied from the vehicle.

In the car navigation apparatus 1320 shown in FIG. 13, the generation unit 110, the coherence type determination unit 130, the measurement unit 140, the selection unit 150, the decoding unit 160, the panel determination unit 170, and the precoding matrix determination unit 180 described in FIG. 1 are implemented by the processor 1321. At least a part of functions may be implemented by the processor 1321. For example, the processor 1321 may execute instructions stored in the memory 1322 to implement the following functions: generating the panel information, generating the beam quality information, determining the intra-panel coherence type, determining the inter-panel coherence type, measuring the channel quality, selecting the preferred beam, decoding the feedback information, determining the panel scheduled by the network side apparatus, and determining the precoding matrix of the panel.

The technology of the present disclosure may also be implemented as a vehicle-mounted system (or a vehicle) 1340 including one or more blocks of the car navigation apparatus 1320, the vehicle-mounted network 1341 and a vehicle module 1342. The vehicle module 1342 generates vehicle data (such as a vehicle speed, an engine speed, and failure information), and outputs the generated data to the vehicle-mounted network 1341.

Preferred embodiments of the present disclosure have been described above with reference to the drawings, but the present disclosure is not limited to the above examples of course. Those skilled in the art may make various alternations and modifications within the scope of the claims. It should be understood that these alternations and modifications shall naturally fall within the technical scope of the present disclosure.

For example, units shown by a dotted line block in the functional block diagram shown in the drawings indicate that the functional units are optional in the corresponding device, and the optional functional units may be combined appropriately to achieve required functions.

For example, multiple functions implemented by one unit in the above embodiments may be implemented by separate apparatus. Alternatively, multiple functions implemented by multiple units in the above embodiments may be implemented by separate apparatus, respectively. Furthermore, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in another sequence appropriately.

The embodiments of the present disclosure have been described above in detail in conjunction with the drawings. However, it should be understood that the embodiments described above are intended to illustrate the present disclosure rather than limit the present disclosure. Those skilled in the art may make various modifications and alternations to the 10 above embodiments without departing from the essence and scope of the present disclosure. Therefore, the scope of the present disclosure is defined by the claims and equivalents thereof.

1. A user equipment comprising:
at least one processor; and
at least one memory including computer program code, where the at least one memory and the computer program code are configured, with the at least one processor, to cause the user equipment to at least:
generate panel information comprising a user capability value set of each of a plurality of panels of the user equipment, wherein user capability values in user capability value sets of different panels are the same or different; and
send the panel information to network side apparatus.

2. The user equipment according to claim 1, wherein the user capability value comprises an intra-panel coherence type, the intra-panel coherence type represents a coherence situation among a plurality of ports of a panel, the coherence situation among the plurality of ports of the panel comprises full coherence, partial coherence, and incoherence.

3. The user equipment according to claim 2, wherein in a case where the plurality of ports of the panel are partially coherent, the coherence situation among the plurality of ports of the panel further comprises partially coherent ports.

4. The user equipment according to claim 1, wherein the at least one memory and the computer program code are further configured, with the at least one processor, to cause the user equipment to:
measure channel quality of each beam according to a reference signal from the network side apparatus:
generate beam quality information for each panel, the beam quality information comprising a preferred beam of the panel and an inter-panel coherence type of the panel, the inter-panel coherence type representing a coherence situation between the panel and other panels, the coherence situation between the panel and the other panels comprising incoherence and coherence: and
send the beam quality information to the network side apparatus.

5. The user equipment according to claim 4, wherein in a case where the panel is coherent with other panels, the coherence situation between the panel and the other panels further comprises information on the other panels coherent with the panel.

6. The user equipment according to claim 4, wherein the at least one memory and the computer program code are further configured, with the at least one processor, to cause the user equipment to:
receive feedback information for the beam quality information from the network side apparatus.

7. The user equipment according to claim 6, wherein the at least one memory and the computer program code are further configured, with the at least one processor, to cause the user equipment to:
send the beam quality information by using PUCCH: and
determine the feedback information by using a DCI format 0 or a DCI format 2, the feedback information comprising ACK and NACK.

8. The user equipment according to claim 6, wherein the at least one memory and the computer program code are further configured, with the at least one processor, to cause the user equipment to:
send the beam quality information by using PUCCH: and
determine the feedback information by using a DCI format 1, the feedback information comprising NACK.

9. The user equipment according to claim 6, wherein the at least one memory and the computer program code are further configured, with the at least one processor, to cause the user equipment to:
send the beam quality information by using PUCCH: and
determine the feedback information by using content of a new data indicator NDI field in a DCI format 0.

10. The user equipment according to claim 1, wherein the at least one memory and the computer program code are further configured, with the at least one processor, to cause the user equipment to:
receive uplink scheduling information from the network side apparatus, the uplink scheduling information comprising one or more detection reference signal SRS resource indicators SRIs: and
determine a plurality of panels for uplink transmission based on the one or more SRIs.

11. (canceled)

12. An electronic apparatus:
at least one processor; and
at least one memory including computer program code, where the at least one memory and the computer program code are configured, with the at least one processor, to cause the electronic apparatus to at least:
receive panel information from user equipment: and
determine a user capability value set of each of a plurality of panels of the user equipment according to the panel information, wherein user capability values in user capability value sets of different panels are the same or different.

13. The electronic apparatus according to claim 12, wherein the user capability value comprises an intra-panel coherence type, the intra-panel coherence type represents a coherence situation among a plurality of ports of a panel, the coherence situation among the plurality of ports of the panel comprises full coherence, partial coherence, and incoherence.

14. The electronic apparatus according to claim 13, wherein in a case where the plurality of ports of the panel are partially coherent, the coherence situation among the plurality of ports of the panel further comprises partially coherent ports.

15. The electronic apparatus according to claim 12, wherein the at least one memory and the computer program code are further configured, with the at least one processor, to cause the electronic apparatus to:
receive beam quality information for each panel from the user equipment: and
determine a preferred beam of the panel and an inter-panel coherence type of the panel based on the beam quality information, the inter-panel coherence type representing a coherence situation between the panel and other panels, and the coherence situation between the panel and the other panels comprising incoherence and coherence.

16. The electronic apparatus according to claim 15, wherein in a case where the panel is coherent with other panels, the coherence situation between the panel and the other panels further comprises information on the other panels coherent with the panel.

17. The electronic apparatus according to claim 15, wherein to the at least one memory and the computer program code are further configured, with the at least one processor, to cause the electronic apparatus to:
generate feedback information for the beam quality information: and
send the feedback information to the user equipment.

18. The electronic apparatus according to claim 17, wherein the at least one memory and the computer program code are further configured, with the at least one processor, to cause the electronic apparatus to:
receive the beam quality information by using PUCCH: and
carry the feedback information by using a DCI format 0 or a DCI format 2, the feedback information comprising ACK and NACK.

19. The electronic apparatus according to claim 17, wherein the at least one memory and the computer program code are further configured, with the at least one processor, to cause the electronic apparatus to:
receive the beam quality information by using PUCCH: and
carry the feedback information by using a DCI format 1, the feedback information comprising NACK.

20. The electronic apparatus according to claim 17, wherein the at least one memory and the computer program code are further configured, with the at least one processor, to cause the electronic apparatus to:
receive the beam quality information by using PUCCH: and
indicate the feedback information by using content of a new data indicator NDI field in a DCI format 0.

21-22. (canceled)

23. A wireless communication method performed by user equipment, comprising:
generating panel information comprising a user capability value set of each of a plurality of panels of the user equipment, wherein user capability values in user capability value sets of different panels are the same or different: and
sending the panel information to network side apparatus.

24.-45. (canceled)
